(19) United States
(12) Patent Application Publication
(10) Pub. No.: US 2005/0248820 A1
(43) Pub. Date: Nov. 10, 2005

(54) System and methods for spectral beam combining of lasers using volume holograms

(76) Inventors: Christophe Moser, Pasadena, CA (US); Karsten Buse, Bonn (DE)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 11/093,135

(22) Filed: Mar. 29, 2005

Related U.S. Application Data
(60) Provisional application No. 60/558,008, filed on Mar. 31, 2004.
(60) Provisional application No. 60/601,058, filed on Aug. 11, 2004.

(51) Int. Cl. G02B 5/32

(52) U.S. Cl. 359/15

(57) ABSTRACT

Volume holographic gratings are used to spectrally combine the emissions from multiple sources into a single output beam. Transmission or reflection gratings are utilized with either laser diode bars, fiber lasers, or fiber collimated light sources. The volume holographic spectral combiner can also be used to feedback and stabilize the wavelength of the sources in an external cavity configuration.

### RELATED APPLICATION

The applicant claims priority to provisional patent application No. 60/558,008 filed Mar. 31, 2004, and provisional patent application No. 60/601,058 filed Aug. 11, 2004.

### BACKGROUND OF THE INVENTION

1. Field of the Invention

The present invention relates to systems and methods for volume holographic spectral beam combining the outputs of laser sources.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

Spectral beam combining is a method of combining into a single output beam the output beams from multiple individual laser sources. This can produce a higher brightness source than is otherwise possible from a single laser source working independently. The conventional approaches utilize dispersive grating elements (“Theory of Spectral Beam Combining of Fiber Lasers”, E. J. Bochove, IEEE J. Quant. Elect., 38:5, 2002), (“Spectral beam combining of a broad-stripe diode laser array in an external cavity”, V. Daneu et. al. Opt. Lett. 25:6, 2000), (U.S. Pat. No. 6,327,292), (U.S. Pat. No. 6,192,062). These are thin grating elements operating either by reflection or transmission, whose dispersion is described by the dispersion relation dθ/dλ=1/(d cos θ₀) where θ is the output angle, λ is the wavelength, and θ₀ is the angle of incidence relative to the grating normal. This approach has limited flexibility, governed mainly by the line spacing of the dispersive element, which dictates the wavelengths of the laser sources and the incidence angles on the dispersive element. It is not possible, for example, to individually control the wavelength of a laser source separately from the others in the system.

Volume hologram reflection gratings have been shown to be an extremely accurate and temperature-stable means of filtering a narrow passband of light from a broadband spectrum. This technology has been demonstrated in practical applications where narrow full-width-at-half-maximum (FWHM) passbands are required. Furthermore, such filters have arbitrarily selectable wavefront curvatures, center wavelengths, and output beam directions.

Photorefractive materials, such as LiNbO₃ crystals and certain types of polymers and glasses, have been shown to be effective media for storing volume holographic gratings such as for optical filters or holographic optical memories with high diffraction efficiency and storage density. In addition, volume gratings Bragg-matched to reflect at normal incidence have been used successfully to stabilize and lock the wavelength of semiconductor laser diodes (U.S. Pat. No. 5,691,989).

FIG. 7 shows a prior art fiber coupling apparatus. An optical element BDM is used to collimate the fast axis of the emitters and displace them in the vertical direction. A second optical element OS stacks the emitters on top of each other at the location of a third optical element BR. The element BR combines the stacked beam into a single direction for fiber coupling.

### SUMMARY OF THE INVENTION

Volume holographic gratings are used to spectrally combine the emissions from multiple sources into a single output beam. Transmission or reflection gratings are utilized with either laser diode bars, fiber lasers, or fiber collimated light sources. The volume holographic spectral combiner can also be used to feedback and stabilize the wavelength of the sources in an external cavity configuration.

### BRIEF DESCRIPTION OF THE DRAWINGS

These and other features, aspects and advantages of the present invention will become better understood with regard to the following description, appended claims and accompanying drawings where:

FIGS. 1A-1B are schematic diagrams of a single spectral beam-combining element utilizing volume holographic gratings in transmission geometry.

FIGS. 2A-2B are schematic diagrams of a single spectral beam-combining element utilizing volume holographic gratings in reflection geometry.

FIG. 3 is a depiction of a laser diode bar spectral beam combining system utilizing a volume holographic element in transmission geometry.

FIGS. 4A-4B is a diagram of a multi-laser volume holographic wavelength locker with discrete gratings or a continuous wavelength variation.

FIG. 5 is a diagram of a volume holographic spectral beam combiner system operating in reflection geometry.

FIGS. 6A and 6B are a schematic of a system utilizing multiple discrete volume holographic beam combiners in reflection geometry.

FIG. 7 is a diagram of a prior art system.

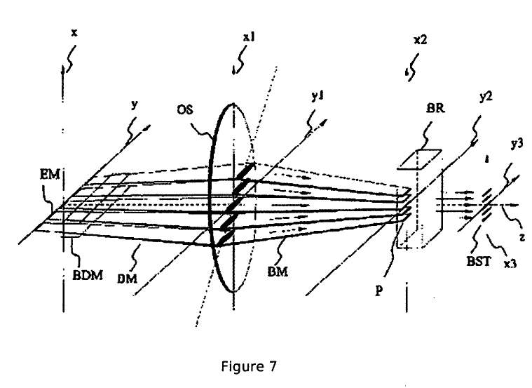

### DETAILED DESCRIPTION OF THE INVENTION

In the following description of the present invention, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Spectral Beam Combination

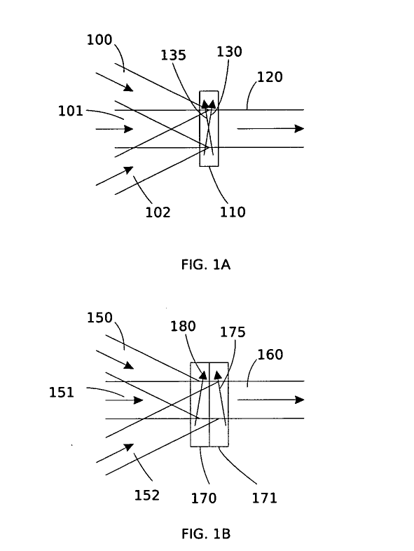

The embodiments of the invention permit a plurality of light beams to be combined into a single output beam, particularly the outputs from a plurality of laser sources. FIG. 1A illustrates one embodiment that uses a transmissive approach to beam combining where multiple volume holographic gratings are multiplexed throughout the volume of an element 110. The input beams, 100, 101, 102, are each at different wavelengths, λ₁, λ₂, λ₃, respectively. Element 110 contains within it, by way of example, two multiplexed volume phase gratings, k₁ and k₂, each with a different grating spacing and tilt angle. Grating k₁ is represented in FIG. 1A as vector 130 and grating k₂ is shown representationally as vector 135. The first grating, k₁, is such that it Bragg-matches the first input beam, 100, with its specific wavelength and angle of incidence, such that it is diffracted into the output beam 120. The second grating, k₂, is such that it Bragg-matches a second input beam 102, with its specific wavelength and angle of incidence, such that it is diffracted into output beam 120. The third input beam, 101, passes through the transparent material of the spectral combiner 110 directly into the output beam, 120. This system is not limited to three input beams, but can be expanded to any number of input beams by, for example, adding for each a corresponding volume holographic grating to the combining element. In one embodiment, one input beam is not changed as it passes through the element, so that n−1 gratings are used for n input beams.

Each grating has a particular spectral response. Each input beam may have a wavelength so that its corresponding grating diffracts it into the output beam. Also, the grating/input beam system may be designed so there is minimal crosstalk between a grating and other beams with which it is not desired to interact. Because multiple input beams get diffracted to overlap in the output beam, the output beam will have more brightness than an individual input beam. The way to determine an appropriate grating depends on the particular angles, wavelengths, thickness of material, etc. Information on how the gratings work can be found in “Coupled Wave Theory for Thick Hologram Gratings”, H. Kogelnik, The Bell System Technical Journal, Vol. 48 No. 9, 1969.

FIG. 1B shows a modification of the scheme in FIG. 1A, where multiple elements 170 and 171 are stacked to work together to form a single spectral beam combiner. A first input beam 150 is Bragg-matched by a grating 180 in the first element 170 and diffracted into the output beam 160. A second input beam 152 is Bragg-matched by a grating 175 in a second element 171 and diffracted into the output beam 160. The third input beam 151 is not Bragg-matched by any gratings, and passes directly through the element into the output beam 160. As noted above, the configuration is not limited to three input beams or two elements, and the ordering of the input beams and gratings is not important. It is possible to have some elements with only one grating, while other elements may have more than one grating multiplexed within a single volume. The criteria for selecting the number of elements and the number of gratings in each element is application specific, and depends on the required wavelength and angle selectivity of each grating, as well as the index modulation depth available from the holographic material used to form the elements.

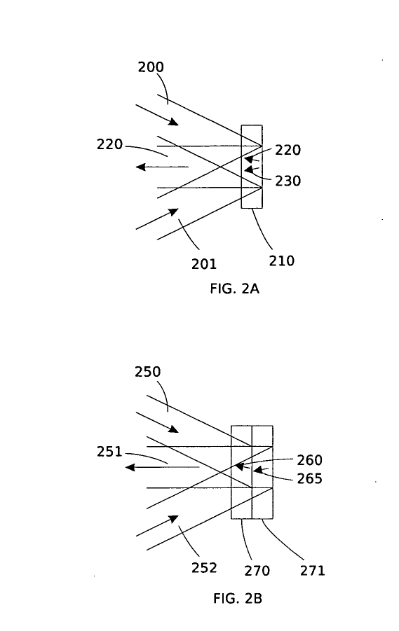

FIG. 2A shows a reflection geometry volume holographic beam combiner where multiple volume holographic gratings are multiplexed throughout the same volume of element 210. The input beams 200 and 201 are each at different wavelengths, λ₁, λ₂, respectively. The element 210 contains within it two multiplexed volume phase gratings, k₁ 220 and k₂ 230 each with a different grating spacing and tilt angle. The first grating, k₁, is such that it Bragg-matches the first input beam 200 with its specific wavelength and angle of incidence, such that it is diffracted with high efficiency into the output beam 220. The second grating, k₂, is such that it Bragg-matches a second input beam 201 with its specific wavelength and angle of incidence, such that it is diffracted with high efficiency into output beam 220. This system is not limited to two input beams, but can be expanded to any number of input beams by adding additional corresponding volume holographic gratings to the combining element as appropriate.

FIG. 2B shows a modification of the scheme in FIG. 2A, where multiple elements 270 and 271 are stacked to work together to form a single spectral beam combiner. A first input beam 250 is Bragg-matched by a grating 260 in the first element 270 and diffracted into the output beam 251. A second input beam 252 is Bragg-matched by a grating 265 in a second element 271 and diffracted into the output beam 251. This configuration is not limited to two input beams or two grating elements, and the ordering of the input beams and gratings is not important. It is possible to have some grating elements with only one grating, while other grating elements have more than one grating multiplexed within a single volume. The criteria for selecting the number of elements and the number of gratings in each element is application specific, and depends on the required wavelength and angle selectivity of each grating, as well as the possible index modulation depth available from the holographic material used to form the elements.

In both transmission and reflection geometry spectral beam combiners, as shown in FIGS. 1A, 1B, 2A, 2B, the source of the incident beams can be from semiconductor laser diodes, fiber-coupled and collimated beams, fiber lasers, gas lasers, or other laser sources.

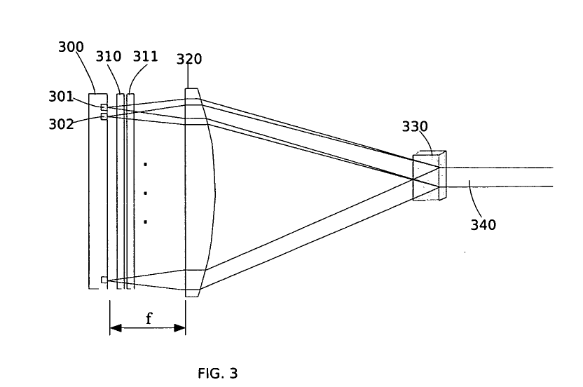

FIG. 3 shows a volume holographic spectral beam combining system. A laser diode bar 300 contains multiple emitters 301 and 302 whose fast axes are collimated with a fast axis collimator 310. A volume holographic wavelength stabilization grating 311 is placed in the beam path to lock each emitter to a different wavelength. The slow axis, in the plane of the figure, is collimated with lens 320 placed one focal length in front of the laser diode bar. Because the emitters are in the front focal plane of the lens 320, the beams are simultaneously redirected such that they overlap at the front-focal plane of the lens. A transmission geometry volume holographic beam combiner 330 is placed at this location so that it will combine all of the beams into a common output beam 340.

Alternatively, volume holographic wavelength locker 311 can be removed, and a partially reflecting mirror can be placed in the path of the output beam 340. The partially reflecting mirror forms the output coupler of an external cavity laser, with parallel paths or cavities between the mirror and each of the emitters. Due to the wavelength and angle selectivity of the spectral beam combiner, each emitter will lock to a separate wavelength. The wavelength of each emitter will be that which yields the lowest loss for its corresponding cavity. Alternatively, the partially reflecting mirror can have a relatively low reflectance and be placed beyond the coherence length of the laser, in which case the laser operates in a coherence-collapsed state as is common in some fiber Bragg grating stabilized pump diodes (“L-I Characteristics of Fiber Bragg Grating Stabilized 980-nm Pump Lasers”, M. Achtenhagen et. al., IEEE Phot. Tech. Lett. Vol. 13 No 5, 2001).

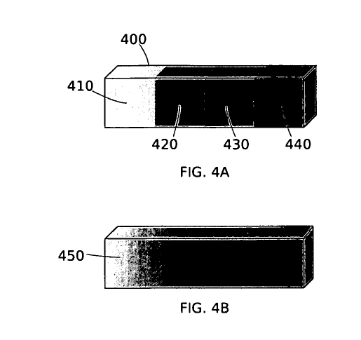

FIG. 4A is a detail view of the discrete volume holographic wavelength locker 400. For each emitter of the laser diode bar with which it is used, it contains a region with a grating, 410, 420, 430, 440, designed to lock the corresponding emitter to a distinct wavelength. The number of grating regions in the element is not limited to four, but in one embodiment is equal to the number of emitters in the laser diode bar. This element allows any emitter to be locked to any wavelength. An alternative design, FIG. 4B, consists of a single region 450 that contains a continuously variable grating spacing, or wavelength chirp. An emitter aligned in front of one side of the element will have a certain wavelength, the emitter next to it will be an amount higher or lower, depending on if the chirp is increasing or decreasing in wavelength, and so on. With this design, the wavelength of an individual emitter cannot be set independently of the others in the bar. The wavelength difference between the emitters is controlled by the chirp rate of the grating. This design has the advantage that it is not required to align separate regions directly in front of corresponding emitters of the laser diode bar. Sliding the chirped wavelength-locking element parallel to the laser diode bar will gradually shift the locked wavelengths of the emitters.

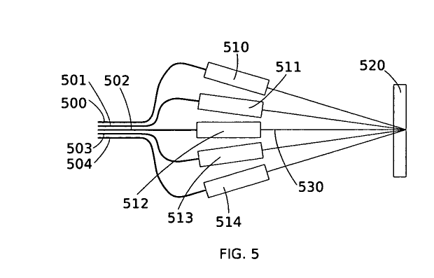

FIG. 5 demonstrates the use of a volume holographic spectral beam combiner 520 operating in the reflection geometry. Four optical fibers, 500, 501, 503, 504, are used as inputs to the system. The light in each fiber is collimated with collimators 510, 511, 513, 514. The collimators are arranged so that their collimated beams will be incident on the spectral combining element at the proper angle for the wavelength of the respective beam such that it will be Bragg matched and diffracted into the path of the output beam 530. The output collimator 512 couples the output beam into the output fiber 502. An alternative implementation forgoes the use of fibers and collimators and instead directly places laser diode elements, each with associated collimating optics, at the proper positions and angles such that their outputs are combined by the volume holographic spectral beam combining element. The invention is not limited strictly to four inputs, but can have more or fewer inputs. The angle and wavelength separations between adjacent inputs does not have to be equal, but must only satisfy the Bragg matching conditions of the volume holographic gratings present in the combining element 520. A partially reflecting mirror may be placed in the path of the output beam 530 in a manner similar to that described for the system of FIG. 3.

In an alternative embodiment an optical system as shown in FIG. 3 is used, but with a reflective combiner element as shown in FIG. 5. The reflective combiner element 520 can be tilted out of the plane such that the output beam 530 is diffracted out of the plane of the input beams to allow for further propagation beyond any packaging or mechanical components that may be present along the plane of the input beams.

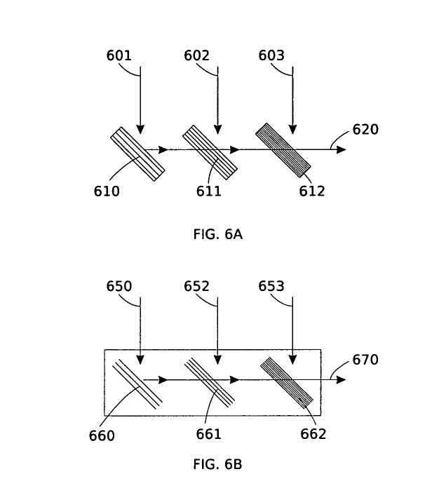

FIG. 6A schematically depicts a spectral beam combining system that utilizes discrete volume holographic gratings. Each input 601, 602, 603, has a wavelength and angle of incidence such that it will Bragg-match the corresponding volume holographic grating 610, 611, 612 and be diffracted into the direction of the output beam 620. The wavelength spacing between inputs is large enough so that undesirable diffraction by subsequent elements is negligible for the application. For example, the wavelength of input 601 is sufficiently spaced from the wavelength of input 602 so that grating 611 does not substantially diffract the light from input 601 that has already been diffracted into the path of the output beam 620. The wavelength separation is determined by the angle of incidence and diffraction of the inputs and the thickness of the volume holographic grating, and is well known in the field and can be calculated through the use of the appropriate references (H. Kogelnik). This invention is not limited to three inputs, but is used only for convenience as an example. The inputs can be from any suitable source, such as a laser diode with collimation optics or light collimated from an optical fiber. The output may remain in free-space, or may be collimated into an optical fiber. The angle between the incident beams and the diffracted beam must not necessarily be 90-degrees.

In an alternative embodiment as shown in FIG. 6B, the combing element is a single piece of transparent material, with the multiple gratings 660, 661, and 662 recorded in separate non-overlapping regions. Input beams 650, 652, and 652 have an angle of incidence and wavelength Bragg matched to gratings 660, 661, and 662 respectively. The result is a combined output beam 670. Alternatively, the gratings can be completely or partially overlapping.

It is to be understood that the invention is not limited to only work with light from lasers, but of any sufficiently collimated source of electro-magnetic radiation, such as microwaves or terahertz waves, and is not limited to any specific range of the electro-magnetic spectrum. The invention is not limited to any specific material that contains volume holographic gratings, but applies to any and all materials that can store amplitude, phase, or some combination of the two, thick volume hologram gratings for use with the appropriate wavelengths of a specific system.

Thus, systems and methods are described in conjunction with one or more specific embodiments. The invention is defined by the claims and their full scope of equivalents.

1. A combining element comprising:
at least one volume holographic transmission grating formed within the element such that spectrally diverse inputs are combined into one output beam.

2. The element of claim 1 wherein the element comprises a plurality of sub-elements wherein each sub-element contains at least one holographic transmission grating.

3. A combining element comprising:
at least one holographic reflection grating formed within the element such that spectrally diverse inputs are combined into one output beam.

4. The element of claim 3 wherein the element comprises a plurality of sub-elements wherein each sub-element has at least one volume holographic reflection grating formed therein.

5. A volume holographic spectral beam combination laser system comprising:
an array of emitters of differing wavelength;
a collimation optic disposed adjacent to the array that redirects beams from the emitters to a common point of intersection;
a combining element disposed at the point of intersection.

6. The system of claim 5 wherein the combining element comprises at least one volume holographic grating formed within the element such that spectrally diverse inputs are combined into one output beam.

7. The system of claim 6 wherein the element comprises a plurality of sub-elements wherein each sub-element contains at least one holographic grating.

8. The system of claim 5 wherein the array of emitters are laser diodes from a laser diode bar.

9. The system of claim 8 wherein the emitters of the laser diode bar are each individually wavelength locked by a discrete volume holographic wavelength locking element.

10. The system of claim 8 wherein the emitters of the laser diode bar are each individually wavelength locked by a continuously chirped volume holographic wavelength locking element.

11. The system of claim 8 further including a partially reflecting mirror introduced to provide wavelength specific feedback into each laser diode emitter, therebye causing it to produce output at a distinct wavelength.

12. The system of claim 5 wherein each emitter is light from an optical fiber.

13. The system of claim 5, where each emitter is a fiber laser.

14. The system of claim 12 further including a partially reflecting mirror introduced to provide wavelength specific feedback into each optical fiber, therebye causing it to produce output at a distinct wavelength.

15. The system of claim 5 wherein each emitter is a distributed feedback laser.

16. The system of claim 5 wherein each emitter is a distributed Bragg-reflector laser.

17. A volume holographic spectral beam combination laser system comprising:
an array of emitters where each emitter is the output from a fiber collimator and is directed towards a volume holographic grating combiner.

18. The system of claim 17 wherein the combiner comprises at least one volume holographic grating formed within the combiner such that spectrally diverse inputs are combined into one output beam.

19. The system of claim 17 wherein the combiner comprises a plurality of sub-elements wherein each sub-element contains at least one holographic grating.

20. The system of claim 17 further including a partially reflecting mirror to produce wavelength specific feedback into the source to cause the production of output at an appropriate wavelength.

21. A volume holographic spectral beam combination laser system comprising:
a plurality of collimated input emitters each at a different wavelength;
a volume holographic grating element corresponding to each emitter designed to diffract the light from its corresponding emitter while passing all other wavelengths where all gratings diffract their emitter's light in the same direction so as to overlap all diffracted light into a single beam path.

22. The system of claim 21 wherein the emitters are each a single laser diode with collimating optics.

23. The system of claim 22 wherein each emitter is wavelength stabilized by a volume holographic grating.

24. The system of claim 22 wherein the emitters are each a distributed feedback laser diode.

25. The system of claim 22 wherein the emitters are each a distributed Bragg reflector laser diode.

26. The system of claim 21 wherein the emitters are the collimated output from an optical fiber.

27. The system of claim 26 wherein the emitters are fiber lasers.

28. The system of claim 21 wherein the emitters are from a common laser diode bar with collimating optics.

29. The system of claim 28 wherein the emitters of the laser diode bar are each individually wavelength locked by a discrete volume holographic wavelength locking element.

30. The system of claim 28 wherein the emitters of the laser diode bar are each individually wavelength locked by a continuously chirped volume holographic wavelength locking element.

31. The system of claim 21 further including a partially reflecting mirror introduced to provide wavelength specific feedback into each source emitter, therebye causing it to produce output at a distinct wavelength.

32. A volume holographic spectral beam combination laser system comprising:
a plurality of collimated input emitters each at a different wavelength;
a combiner element comprising a volume holographic grating corresponding to each emitter and designed to diffract the light from its corresponding emitter while passing all other wavelengths, where the gratings diffract their emitter's light in the same direction so as to overlap the diffracted light into a single beam path.

33. The system of claim 32 wherein the emitters are each a single laser diode with collimating optics.

34. The system of claim 33 wherein each emitter is wavelength stabilized by a volume holographic grating.

35. The system of claim 33 wherein the emitters are each a distributed feedback laser diode.

36. The system of claim 33 wherein the emitters are each a distributed Bragg reflector laser diode.

37. The system of claim 32 wherein the emitters are the collimated output from an optical fiber.

38. The system of claim 37 wherein the emitters are fiber lasers.

39. The system of claim 32 wherein the emitters are from a common laser diode bar with collimating optics.

40. The system of claim 39 wherein the emitters of the laser diode bar are each individually wavelength locked by a discrete volume holographic wavelength locking element.

41. The system of claim 39 wherein the emitters of the laser diode bar are each individually wavelength locked by a continuously chirped volume holographic wavelength locking element.

42. The system of claim 32 further including a partially reflecting mirror introduced to provide wavelength specific feedback into each source emitter, therebye causing it to produce output at a distinct wavelength.
